(19) United States
(12) Patent Application Publication
(10) Pub. No.: US 2020/0335908 A1
(43) Pub. Date: Oct. 22, 2020

(54) CONNECTOR

(71) Applicant: Yazaki Corporation, Tokyo (JP)

(72) Inventors: Jun ISHIKAWA, Tokyo (JP); Kazuto Ohtaka, Shizuoka (JP)

(73) Assignee: Yazaki Corporation, Tokyo (JP)

(21) Appl. No.: 16/850,289

(22) Filed: Apr. 16, 2020

(30) Foreign Application Priority Data
Apr. 18, 2019 (JP) 2019-079211

(51) Int. Cl. H01R 13/629; H01R 13/627

(52) U.S. Cl. CPC H01R 13/62938; H01R 13/6272; H01R 13/62955

(57) ABSTRACT

A lever-type connector includes a female housing. A panel latching section, a flange, a flexible arm, and a locking protrusion are formed on the outer side of the female housing. The locking protrusion is formed in the center of the flexible arm. The locking protrusion is locked to hold a vehicle body panel between the locking protrusion and a flange. The lever-type connector is locked by, in a state in which the panel latching section is hooked to an edge portion, rotating the female housing with the panel latching section as a fulcrum and bringing a locking surface of the locking protrusion into contact with a wall surface of the vehicle body panel.

### CROSS-REFERANCE TO RELATED APPLICATIONS

The present application is based on, and claims priority from Japanese Patent Application No. 2019-079211, filed on Apr. 18, 2019, the entire contents of which are incorporated herein by reference.

### TECHNICAL FIELD

The present application relates to a connector such as a lever-type connector.

### BACKGROUND

JP 2002-359036 A discloses a lever-type connector assembled to a panel of an automobile.

The lever-type connector includes a first connector housing, a lever, and a second connector housing. An elastic slip-off preventing piece including a protrusion is formed in the first connector housing. The lever-type connector is attached by locking the protrusion of the elastic slip-off preventing piece of the first connector housing to an attachment hole of the panel in a state in which the second connector housing is fit in the first connector housing.

### SUMMARY

However, in the lever-type connector, a locking surface of the protrusion of the elastic slip-off preventing piece of the first connector housing is formed as a slope (a taper) in a coming-off direction. Therefore, clearance for the slope in the coming-off direction of the locking surface causes a locking backlash. As a result, locking holding power of the protrusion of the elastic slip-off preventing piece decreases.

When the lever-type connector is removed, it is likely that the distal end of a releasing jig drops into a slit beside the elastic slip-off preventing piece to deteriorate removal workability and damage the elastic slip-off preventing piece.

The present application has been made in order to solve the problems described above, and an object of the present application is to provide a connector that can prevent halfway locking in assembling to a panel and can improve removal workability from the panel.

A connector according to the present application includes a housing, on an outer side of which a panel latching section hooked to an edge portion of an attachment hole of a panel and latched to the edge portion, an annular flange opposed to the edge portion, a flexible arm, and a locking protrusion holding the panel between the locking protrusion and the flange and locked to the panel are respectively formed. A slit is formed between the flange and the flexible arm. The locking protrusion is formed in the flexible arm. In a state in which the panel latching section is hooked to the edge portion of the attachment hole, the housing is rotated with the panel latching section as a fulcrum to bring a locking surface of the locking protrusion into contact with a wall surface of the panel and lock the locking surface.

According to the present application, when the housing is assembled to the panel, the flexible arm bends and the locking surface of the locking protrusion and the wall surface of the panel are brought into contact and locked. Therefore, fluctuation in a locking margin of the locking protrusion does not occur. It is possible to stably maintain holding power of the panel locking. When the housing is removed from the panel, a releasing jig only has to be operated along the flange. Therefore, it is possible to improve workability in removing the housing from the panel.

### BRIEF DESCRIPTION OF THE DRAWINGS

FIG. 1 is a perspective view illustrating a state before fitting of a lever-type connector according to an embodiment of the present application;

FIG. 2 is a perspective view of a male connector of the lever-type connector;

FIG. 3 is a perspective view of a lever of the lever-type connector;

FIG. 4 is a side view of the male connector at temporary set releasing time;

FIG. 5 is an enlarged view of a Y portion in FIG. 4;

FIG. 6 is a bottom view of the male connector at the temporary set releasing time;

FIG. 7 is a plan view of the male connector at the temporary set releasing time;

FIG. 8 is a perspective view of a frame of a female connector of the lever-type connector;

FIG. 9 is an enlarged side view of a main part of the frame;

FIG. 10 is a perspective view of a grommet attached to a flange of the frame;

FIG. 11 is a side view illustrating a state before temporary set of the lever-type connector;

FIG. 12A is a side view illustrating a temporary set state at lever rotation start time of the lever-type connector;

FIG. 12B is a sectional view along a X-X line in FIG. 12A;

FIG. 13A is a side view illustrating a state at lever rotation completion time of the lever-type connector;

FIG. 13B is a schematic sectional view along a X-X line in FIG. 13A;

FIG. 14 is a side view illustrating a state in which slide of the lever of the lever-type connector is completed;

FIG. 15 is a side view illustrating a state in which the lever-type connector is pierced through an attachment hole of a vehicle body panel;

FIG. 16 is a perspective view illustrating a state in which the lever-type connector is pierced through the attachment hole of the vehicle body panel;

FIG. 17 is a side view illustrating a state in which a panel latching section of the lever-type connector is inserted into the attachment hole of the vehicle body panel;

FIG. 18 is a side view illustrating a state in which the panel latching section of the lever-type connector is latched to an edge portion of the attachment hole of the vehicle body panel;

FIG. 19 is a perspective view illustrating a state in which the panel latching section of the lever-type connector is not latched to the edge portion of the attachment hole of the vehicle body panel;

FIG. 20 is a side view illustrating a state in which the lever-type connector is assembled to the vehicle body panel;

FIG. 21 is a sectional view along a X-X line in FIG. 20;

FIG. 22 is a side view illustrating a state immediately before the grommet is removed;

FIG. 23 is a perspective view illustrating a state in which the grommet is removed;

FIG. 24 is a side view illustrating a state in which a releasing jig is inserted between the vehicle body panel and the flange of the frame and a locking protrusion of the female connector is released;

FIG. 25 is a sectional view along a Y-Y line in FIG. 24;

FIG. 26A is a perspective view illustrating a state in which the releasing jig is inserted between the vehicle body panel and the flange of the frame and the locking protrusion of the female connector is released;

FIG. 26B is an enlarged side view of the main part in the releasing state;

FIG. 27 is a side view illustrating a state in which the female connector is removed from the vehicle body panel;

FIG. 28 is a perspective view illustrating a state in which the female connector is removed from the vehicle body panel;

FIG. 29 is a side view illustrating a state in which the male connector is removed from the vehicle body panel;

FIG. 30 is a perspective view illustrating a state in which the male connector is removed from the vehicle body panel;

FIG. 31 is a sectional view illustrating a panel attachment state of a lever-type connector according to a comparative example; and

FIG. 32 is a perspective view of a first connector housing in a state in which a lever of the lever-type connector according to the comparative example is present in a waiting position.

### DETAILED DESCRIPTION

Hereinafter, an embodiment of the present application will be described with reference to the drawings.

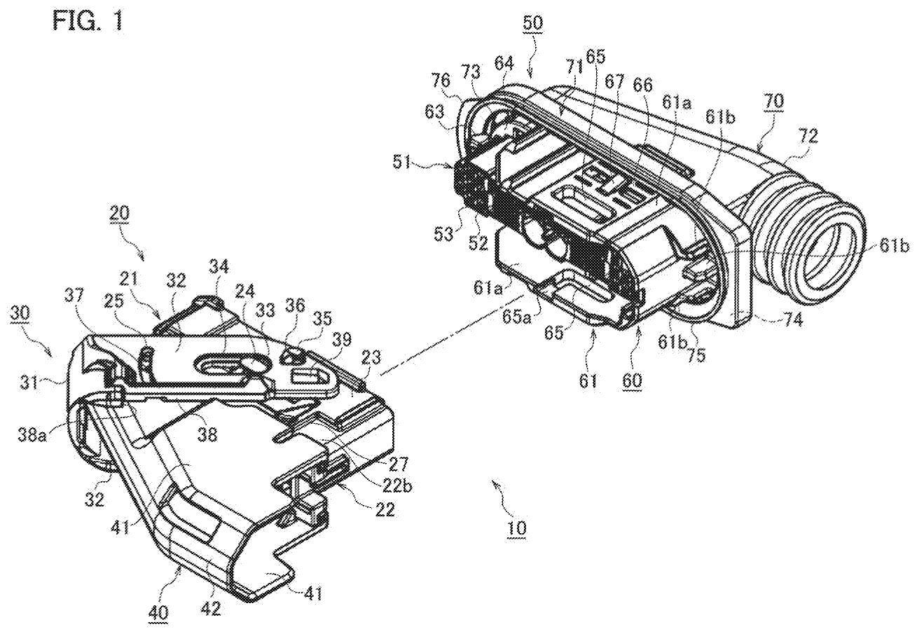

The embodiment of the present application will be described with reference to FIGS. 1 to 30.

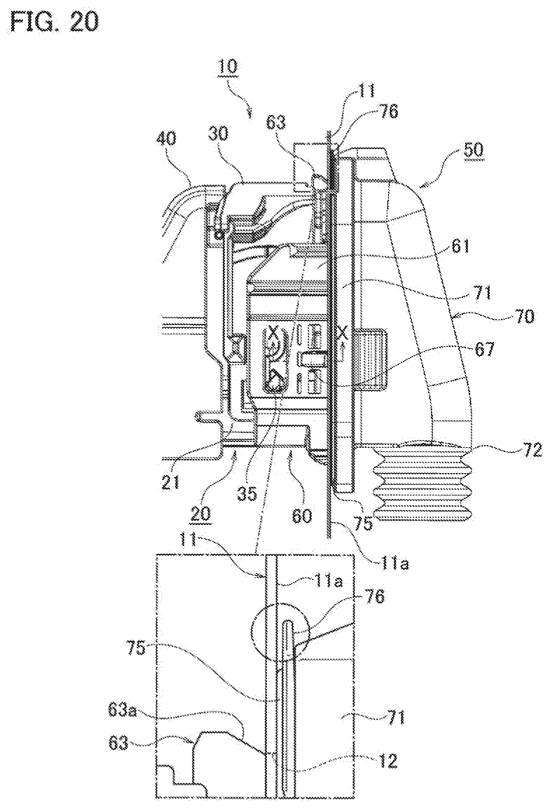

As illustrated in FIG. 1, a lever-type connector 10 includes a male connector 20 and a female connector (a connector) 50. As illustrated in FIG. 16, when the lever-type connector 10 is assembled to an attachment hole 12 of a vehicle body panel 11, the male connector 20 fit in the female connector 50 is pierced through the attachment hole 12 of the vehicle body panel 11 from a door panel side. As illustrated in FIG. 20, after the lever-type connector 10 is assembled to the attachment hole 12 of the vehicle body panel 11, the male connector 20 is arranged on the inner side (the opposite side of a door) of the vehicle body panel (a panel) 11. The female connector 50 is arranged on the outer side (the door side) of the vehicle body panel 11. In FIG. 16, a direction in which the lever-type connector 10 is pierced through the attachment hole 12 of the vehicle body panel 11 is represented as a piercing-through direction. In FIG. 20, a perpendicular direction in FIG. 20 orthogonal to the piercing-through direction and in which the vehicle body panel 11 extends is represented as a vertical direction. In FIGS. 1 and 20, a direction orthogonal to the piercing-through direction and in which both sidewall sections 61a, 61a of a frame body 61 described below are opposed when the lever-type connector 10 is pierced through the attachment hole 12 is represented as a width direction.

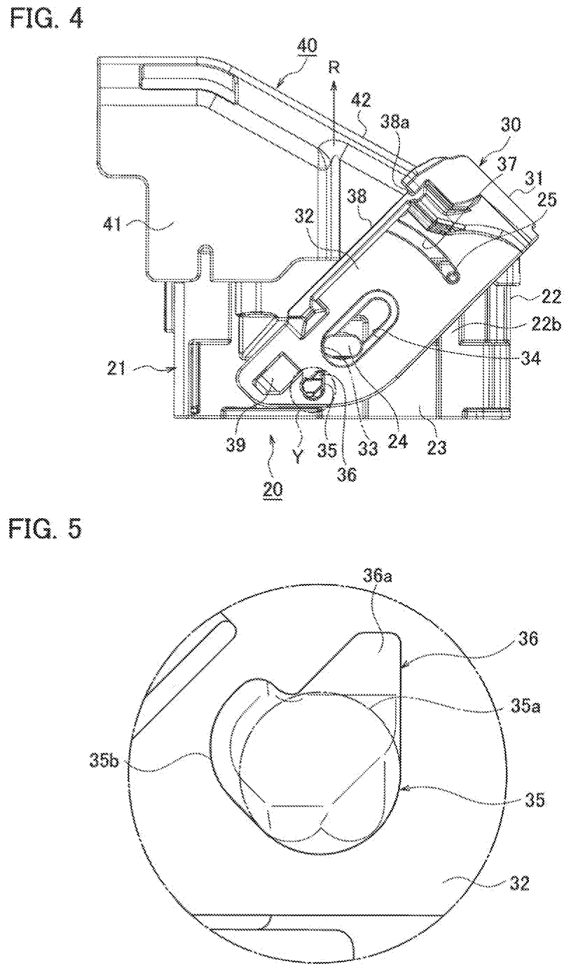

As illustrated in FIGS. 1, 4, and 6, the male connector 20 includes a male housing 21 made of synthetic resin, a lever 30 made of synthetic resin, and a cable cover 40 made of synthetic resin. The male housing 21 houses a not-illustrated plurality of male terminals (terminals). The male housing 21 is fit in and separated from a female housing 51 of the female connector 50. The lever 30 is supported to be capable of rotating and sliding by the male housing 21 via supporting shafts 24, 24 (in FIGS. 1 and 4, only one supporting shaft 24 is illustrated). The lever 30 fits and separates the male housing 21 and the female housing 51 according to rotation operation. The cable cover 40 is attached to the male housing 21 to cover the rear side of the male housing 21 (the opposite side of a side where the male connector 20 is opposed to the female connector 50).

As illustrated in FIGS. 1, 2, and 6, the male housing 21 includes a rectangular block-like housing body 22 and a hood section 23. The housing body 22 includes a plurality of terminal housing holes 22a in which male terminals are housed. The hood section 23 is integrally formed to project on the front side of the housing body 22 (the side where the male connector 20 is opposed to the female connector 50). A housing body 52 of the female housing 51 is fit in the inside of the hood section 23. The supporting shafts 24, 24 extending in a direction perpendicular to a connector fitting direction are respectively integrally formed to project in a boundary between the center of both side surfaces 22b, 22b of the housing body 22 and the hood section 23. The supporting shafts 24, 24 are turning shafts of the lever 30.

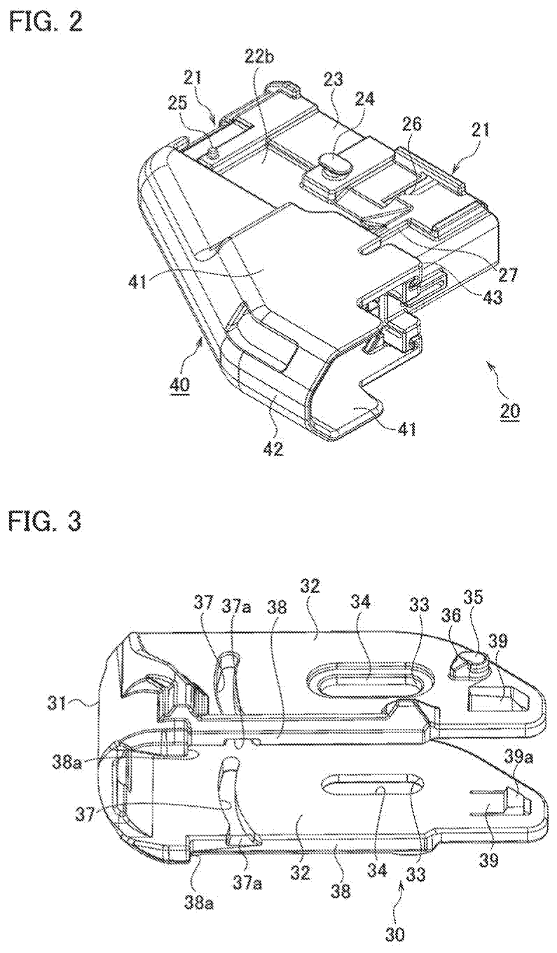

Guide protrusions 25, 25 are respectively integrally formed to project on the rear side of both the side surfaces 22b, 22b of the housing body 22 (the opposite side of the side where the male connector 20 is opposed to the female connector 50) and in positions closer to an operation section 31 of the lever 30 described below. As illustrated in FIG. 2, a temporary locking recess (a temporary locked section) 26 and a regular locking recess (a regular locked section) 27 are respectively formed in positions in the hood section 23 and both side surfaces 22b, 22b of the housing body 22 corresponding to positions on a rotation track of a protrusion section 39a of a locking arm (a locking section) 39 of the lever 30 described below.

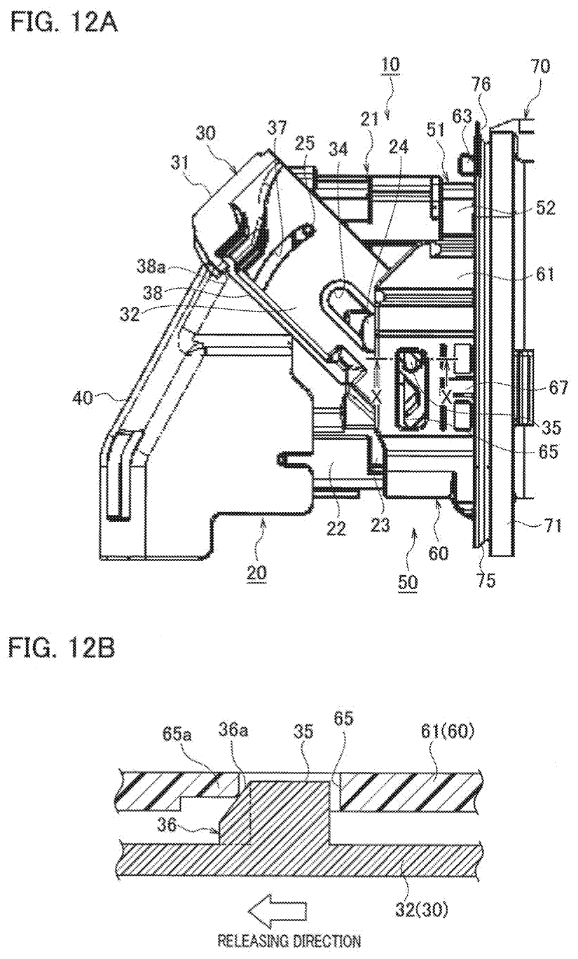

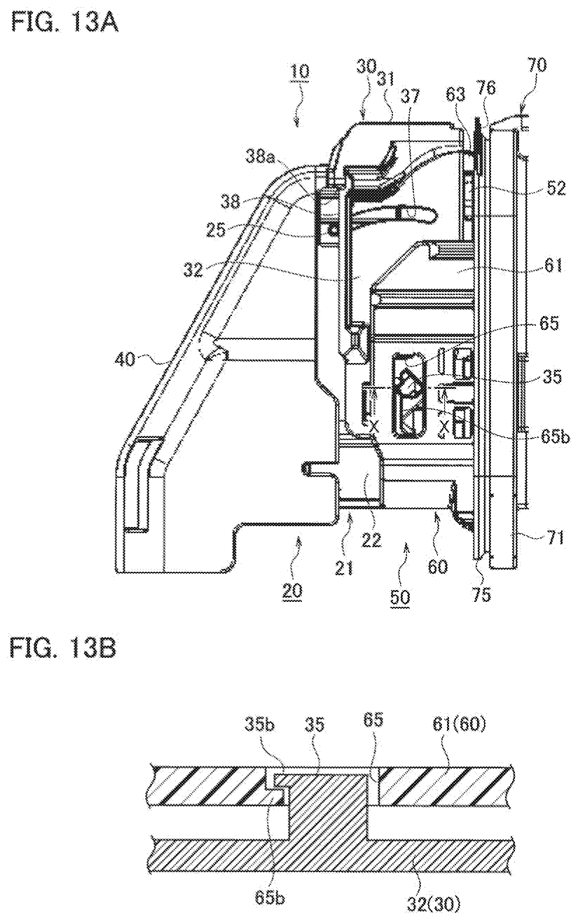

As illustrated in FIGS. 1, 3, and 4, the lever 30 is attached to the male housing 21 to cover a part of the male housing 21 of the male connector 20 and a part of the cable cover 40. The lever 30 draws the male connector 20 and the female connector 50 to each other and fits the male connector 20 and the female connector 50 according to rotation operation from a lever rotation start position illustrated in FIG. 12A to a lever rotation completion position illustrated in FIG. 13A. The lever 30 includes the operation section 31 and a pair of arm sections 32, 32 extending from both sides of the operation section 31.

As illustrated in FIGS. 1, 3, and 4, a bearing hole (a bearing section) 33 is formed in the center of each arm section 32 of the lever 30. The bearing hole 33 includes a shaft sliding groove 34 in which the supporting shaft 24 slides. A columnar cam boss 35 is integrally formed to project in each arm section 32.

As illustrated in FIGS. 4 to 7, 12A, and 12B, a protrusion 36 including a taper section 36a is integrally formed to project on the outer side in a temporary set releasing direction (a connector separating direction) R of the cam boss 35. When the male connector 20 and the female connector 50 are fit, the taper section 36a inclines to be opposed to a surface on the temporary set releasing direction R side in a temporary locking protrusion 65a of a cam groove 65 described below. As illustrated in FIGS. 5 and 13B, a position restriction rib 35b, which engages with a drawing-in rib 65b of the cam groove 65, is integrally formed to project at the upper end of the shaft section 35a of the cam boss 35.

As illustrated in FIG. 3, in each arm section 32, an arcuate guide groove 37, in which the guide protrusion 25 engages, is formed between the operation section 31 and the bearing hole 33. The guide groove 37 is formed in an elongated arcuate shape centering on the bearing hole 33. A gathering taper 37a for guiding the guide protrusion 25 is formed on an opening end side of the guide groove 37.

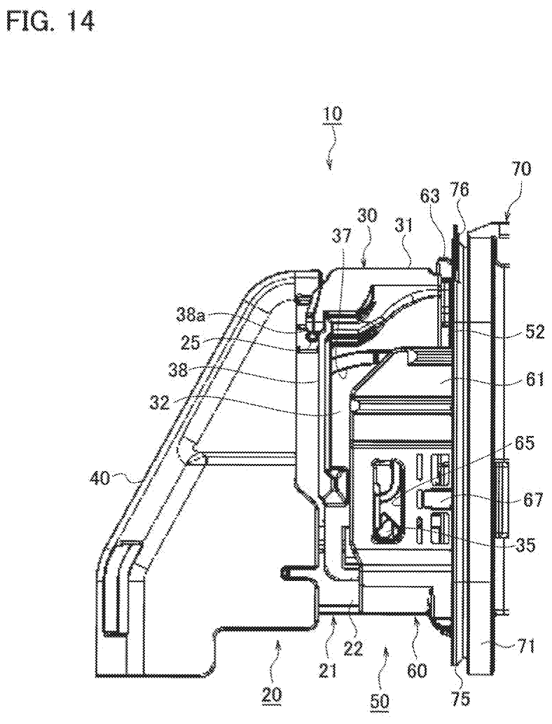

As illustrated in FIG. 3, a sliding section 38, in which the guide protrusion 25 slides in a sliding direction after the rotation of the lever 30, is provided in each arm section 32 of the lever 30. The sliding section 38 is formed in a rail shape recessed on the inner side. Further, in each arm section 32, a contact section 38a, with which the guide protrusion 25 is in contact at a sliding terminal end after the rotation of the lever 30, is provided. After the guide protrusion 25 slides in the guide groove 37 according to the rotation operation of the lever 30 and fitting of the male connector 20 and the female connector 50 is completed, the guide protrusion 25 slides along the sliding section 38 until guide protrusion 25 hits the contact section 38a. With such a configuration, as illustrated in FIGS. 13A and 14, the lever 30 can slide with respect to the housing body 22 of the male housing 21.

As illustrated in FIGS. 1 and 3, the locking arm (the locking section) 39, which is elastically deformed in a direction perpendicular to a fitting direction of a housing, is formed on the outer side of the distal end of each arm section 32 of the lever 30. The protrusion section 39a of the locking arm 39 is locked to and separated from a temporary locking recess 26 or a regular locking recess 27. With such a configuration, the locking arm 39 locks the lever 30 to and separates the lever 30 from the temporary locking recess 26 or the regular locking recess 27.

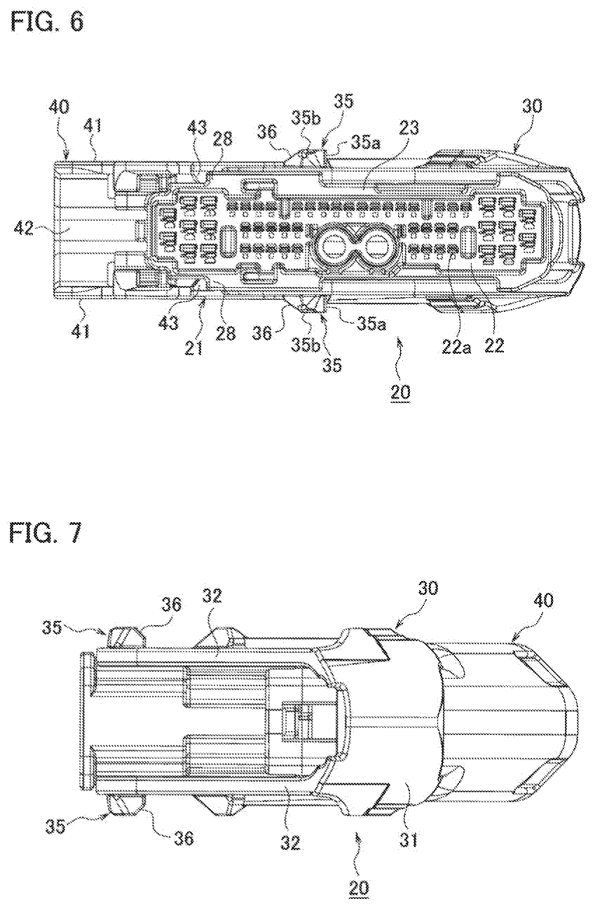

As illustrated in FIGS. 1 and 2, the cable cover 40 includes a pair of sidewall sections 41, 41, which forms an opening section, and a ceiling wall section 42 having a curved surface shape or a bent shape. As illustrated in FIG. 6, when the cable cover 40 is slid and attached to the rear end side (the end portion on the opposite side of the side where the male connector 20 is opposed to the female connector 50) of the housing body 22 of the male housing 21, lock sections 43 formed at the lower ends of the sidewall sections 41, 41 are locked to a locked section 28 formed in the housing body 22.

As illustrated in FIG. 1, the female connector (the connector) 50 attached with a grommet includes the female housing 51 and a grommet 70 made of rubber. The female housing 51 includes a plurality of terminal housing chambers 53 that house not-illustrated female terminals (terminals). The female housing 51 includes the housing body 52 made of synthetic resin and a tubular frame 60 made of synthetic resin. The housing body 52 is fit in and separated from the male housing 21 of the male connector 20. The frame 60 is fit in and sheathed over the outer periphery of the housing body 52 and locked to the attachment hole 12 of the vehicle body panel 11. The grommet 70 is attached to a flange 62 of the frame 60.

As illustrated in FIG. 1, the housing body 52 includes a plurality of terminal housing chambers 53, in which female terminals are housed, and is formed in a rectangular block shape. In positions opposed to the temporary locking recesses 26, 26 formed on both the side surfaces 22b, 22b of the male housing 21 on both side surfaces of the housing body 52, not-illustrated releasing protrusions (releasing sections), which release a temporary locked state of the protrusion section 39a of the locking arm 39 of the lever 30 and the temporary locking recess 26, are respectively formed.

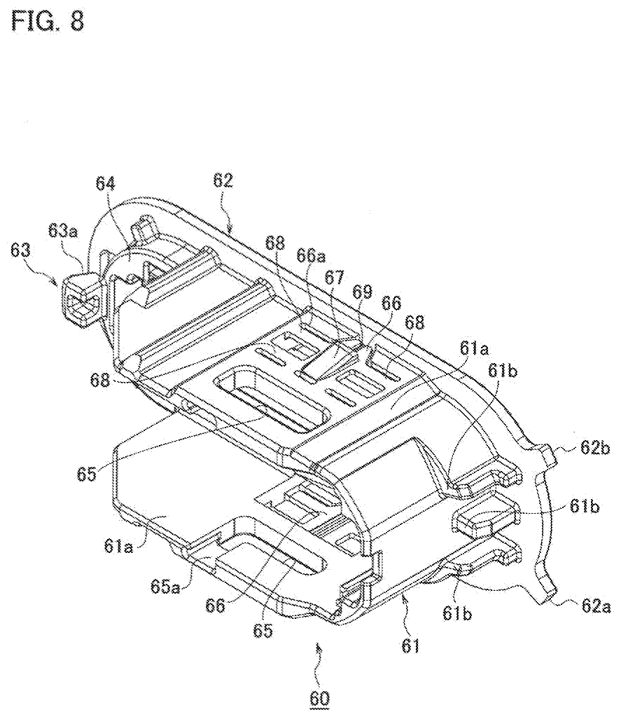

As illustrated in FIG. 8, the frame 60 includes the tubular frame body 61 cut out on the upper surface side and the annular flange 62. The flange 62 is integrally formed to project toward the outer side in the entire periphery on one end side of the frame body 61. The flange 62 is opposed to an edge portion 12a of the attachment hole 12 of the vehicle body panel 11 when the female connector 50 is attached to the vehicle body panel 11.

A panel latching section 63 hooked and latched to the edge portion 12a of the attachment hole 12 is provided on the upper side of the frame body 61. In a state in which the panel latching section 63 is hooked to the edge portion 12a of the attachment hole 12, by rotating the female housing 51 with the panel latching section 63 as a fulcrum, a locking protrusion 67 described below can be locked to the attachment hole 12. A gathering taper 63a is formed on the flange 62 side of the panel latching section 63.

As illustrated in FIGS. 1 and 8, a locking frame section 64 is provided on the lower side of the panel latching section 63 of the frame body 61. The locking frame section 64 locks the housing body 52 of the female housing 51 internally mounted with a gap in both the sidewall sections 61a, 61a of the frame body 61. A pair of abutting sections 61b, 61b is provided on the lower side of the frame body 61. The abutting sections 61b, 61b hit the vehicle body panel 11 when the locking protrusion 67 described below is not correctly locked to the attachment hole 12 of the vehicle body panel 11. The hood section 23 of the housing body 22 of the male housing 21 is fit between the housing body 52 of the female housing 51 and the tubular frame body 61 of the frame 60. In positions opposed to the abutting sections 61b, 61b located on both end sides of the flange 62 of the frame 60, a pair of protrusion sections 62a, 62b is integrally formed to project on the outer side of the flange 62. The protrusion sections 62a, 62b are inserted into, without being pierced through, a deep groove section 74 formed in the depth of a flange fitting groove 73 of the grommet 70 described below.

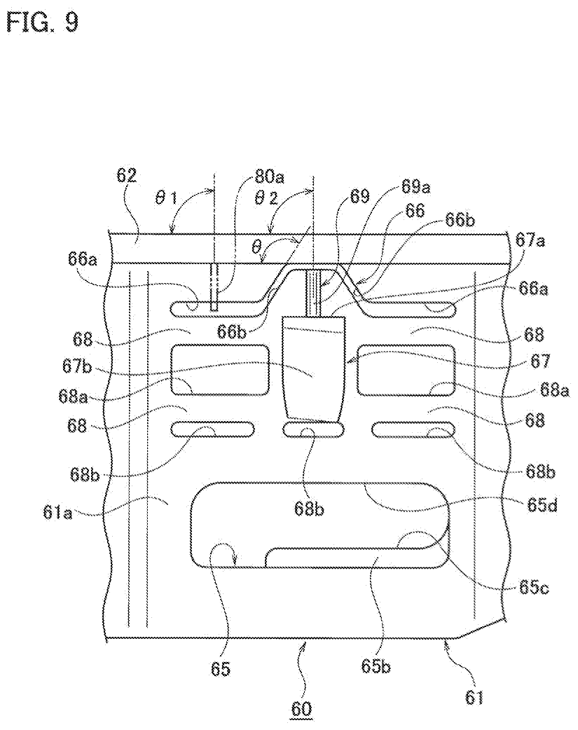

As illustrated in FIGS. 8 and 9, the cam grooves 65, 65, in which the cam boss 35 of the lever 30 engages, are respectively formed on the opposite side of the flange 62 in the center of both the sidewall sections 61a, 61a of the frame body 61. Each cam groove 65 includes the temporary locking protrusion 65a, the drawing-in rib 65b, and a pushing-out side sliding surface 65d. The temporary locking protrusion 65a is provided on an inlet side of the cam groove 65. A drawing-in side sliding surface 65c extending in an L shape from the temporary locking protrusion 65a is formed in the drawing-in rib 65b. The pushing-out side sliding surface 65d is opposed to the drawing-in side sliding surface 65c of the drawing-in rib 65b.

As illustrated in FIG. 9, an elastically deformable flexible arm 66 is integrally formed in a position on the flange 62 side in the center of both the sidewall sections 61a, 61a of the frame body 61. Linear slits 66a, 66a and inclined slits 66b, 66b on both the left and right sides and a center slit 66c are formed between the flexible arm 66 and the flange 62. The flexible arm 66 is cantilevered by the sidewall section 61a. The locking protrusion 67 is integrally formed to project in the center of the flexible arm 66. As illustrated in FIG. 21, the locking protrusion 67 holds the vehicle body panel 11 between the locking protrusion 67 and the flange 62 via a water-stop lip 75 of the grommet 70 described below. The locking protrusion 67 includes a locking surface 67a perpendicular to the surface of the sidewall section 61a and parallel to the vehicle body panel 11 and an inclined surface (a taper) 67b for guiding. The locking surface 67a is locked to the edge portion 12a of the attachment hole 12 of the vehicle body panel 11 between the locking protrusion 67 and the flange 62. The inclined surface (the taper) 67b for guiding comes into contact with the edge portion 12a when the female housing 51 is assembled to the attachment hole 12. The inclined surface 67b is formed such that the vehicle body panel 11 and the locking protrusion 67 forms a right angle even if the female housing 51 tilts when the female housing 51 is assembled to the attachment hole 12.

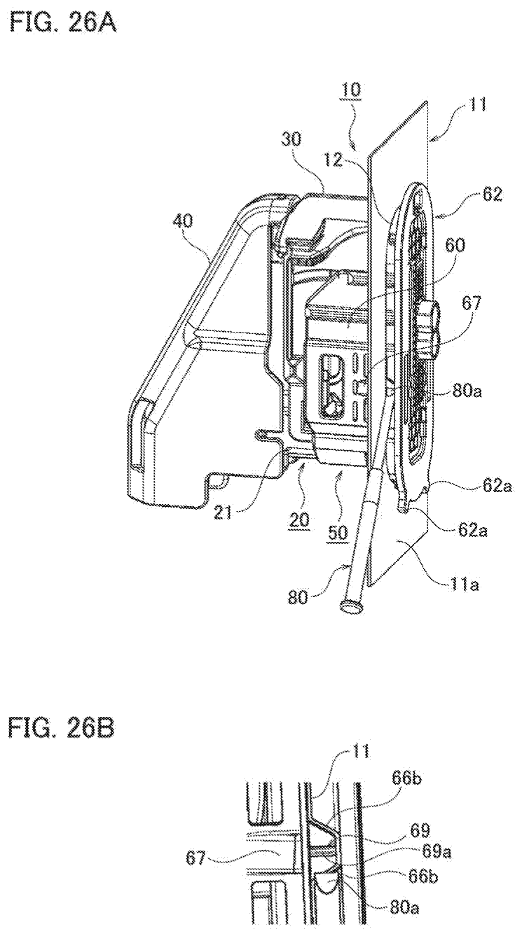

As illustrated in FIG. 9, a pair of auxiliary arms 68, 68 is formed on both sides of the locking protrusion 67 of the flexible arm 66 via a rectangular cutout section 68a and a slit 68b. The auxiliary arms 68, 68 extend in a direction orthogonal to the locking protrusion 67 of the flexible arm 66 (the vertical direction in assembling the lever-type connector 10 to the attachment hole 12 of the vehicle body panel 11). A releasing section 69 operated by a releasing jig 80 inserted along the flange 62 is formed between the locking protrusion 67 of the flexible arm 66 and a center slit 66c. A recessed groove 69a, which the distal end of the releasing jig can enter, is formed in the releasing section 69. When the releasing jig 80 is inserted along the flange 62, an insertion angle θ1 of a distal end 80a of the releasing jig 80 with respect to the flange 62 is set to the same angle as an angle θ2 of the recessed groove 69a of the releasing section 69 with respect to the flange 62. When the releasing jig 80 is inserted along the flange 62, the insertion angle θ1 of the distal end 80a of the releasing jig 80 with respect to the flange 62 is set to an angle different from an inclination angle θ of an inclined slit 66b with respect to the flange 62. As illustrated in FIGS. 9 and 26B, the insertion angle θ1 of the distal end 80a of the releasing jig 80 is an angle formed by the distal end 80a of the releasing jig 80 with respect to an extending direction of the flange 62 (a crosswise direction at the time when the frame side view of FIG. 9 is viewed in the front and is a vertical direction in assembling the lever-type connector 10 to the attachment hole 12 of the vehicle body panel 11) when the releasing jig 80 is inserted in a gap between the flange 62 and the vehicle body panel 11. The angle θ2 of the recessed groove 69a of the releasing section 69 is an angle formed by the recessed groove 69a of the releasing section 69 with respect to the extending direction of the flange 62 (the crosswise direction at the time when the frame side view of FIG. 9 is viewed in the front and is the vertical direction in assembling the lever-type connector 10 to the attachment hole 12 of the vehicle body panel 11). The inclination angle θ of the inclined slit 66b is an angle formed by the inclined slit 66b with respect to the extending direction of the flange 62 (the crosswise direction at the time when the frame side view of FIG. 9 is viewed in the front and is the vertical direction in assembling the lever-type connector 10 to the attachment hole 12 of the vehicle body panel 11).

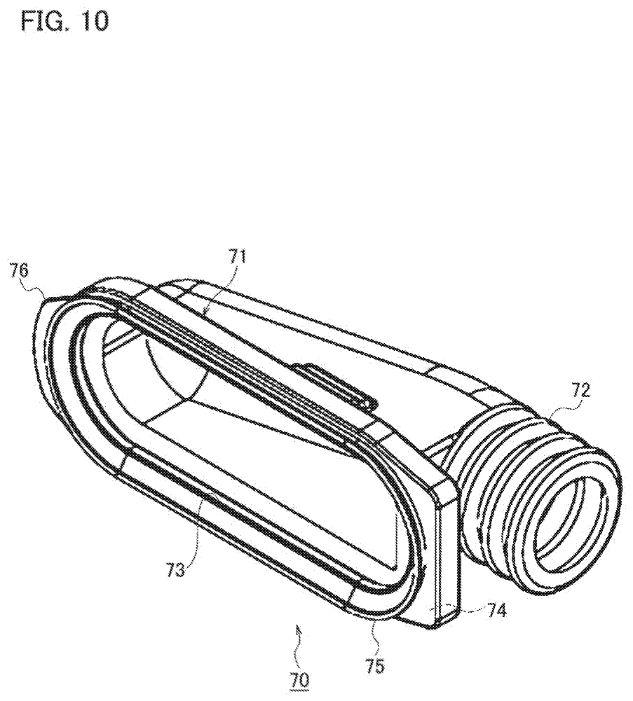

As illustrated in FIGS. 1 and 10, the grommet 70 includes a panel adhering section 71 and a cable housing section 72. The panel adhering section 71 fits in the flange 62 to cover the flange 62. The panel adhering section 71 adheres to the edge portion 12a of the attachment hole 12 of the vehicle body panel 11 when the female connector 50 is attached to the vehicle body panel 11.

As illustrated in FIG. 10, the flange fitting groove 73 is formed on the inner side of the panel adhering section 71. The flange 62 is inserted into the flange fitting groove 73 over the entire circumference of the flange 62. The deep groove section 74 is formed on the lower side of the flange fitting groove 73. The protrusion sections 62a, 62b of the flange 62 are inserted into the deep groove section 74 without piercing through the deep groove section 74. The water-stop lip 75 is integrally formed on the outer side of the panel adhering section 71. When the female connector 50 is attached to the vehicle body panel 11, the water-stop lip 75 is pressed against a wall surface 11a around the edge portion 12a of the attachment hole 12 of the vehicle body panel 11 and adheres to the edge portion 12a. A guide rib 76 is integrally formed to project in a tongue piece shape in a position opposed to the panel latching section 63 of the frame 60 of the panel adhering section 71. The guide rib 76 comes into contact with the wall surface 11a of the vehicle body panel 11 earlier than the water-stop lip 75 when the female housing 51 is assembled to the vehicle body panel 11. The guide rib 76 separates from and does not come into contact with the wall surface 11 a of the vehicle body panel 11 after the female housing 51 is attached to the attachment hole 12. In this case, the water-stop lip 75 is pressed against and adheres to the wall surface 11 a of the vehicle body panel 11.

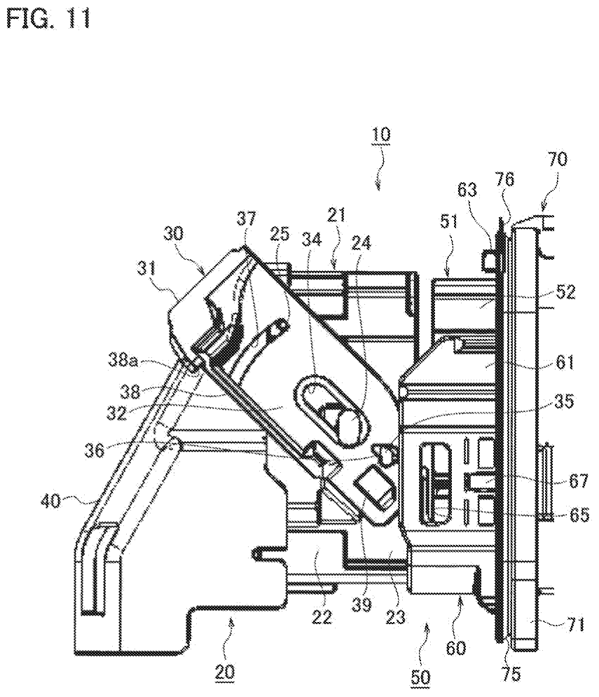

As described above, with the lever-type connector 10 in the embodiment, before the lever-type connector 10 is assembled to the attachment hole 12 of the vehicle body panel 11 (before temporary set), as illustrated in FIGS. 4 and 11, the bearing holes 33, 33 including shaft sliding grooves 34, 34 of the lever 30 are assembled to the supporting shafts 24, 24 of the male housing 21 of the male connector 20 and the protrusion section 39a of the locking arm 39 of the lever 30 is temporarily locked to the temporary locking recess 26 of the male housing 21 to retain a temporary locked state of the lever 30. When the lever 30 is in the temporary locked state with respect to the male housing 21, the lever 30 cannot be rotated in the fitting direction of the male housing 21 and the female housing 51 of the female connector 50.

In the temporary locked state of the lever 30, when the housing body 52 of the female housing 51 is pushed into the hood section 23 of the male housing 21, a not-illustrated releasing protrusion of the housing body 52 elastically deforms the locking arm 39 of the lever 30 to the outer side. Consequently, the temporary locked state of the temporary locking recess 26 of the male housing 21 and the protrusion section 39a of the locking arm 39 of the lever 30 is released. The lever 30 can rotate in the fitting direction of the male housing 21 and the female housing 51.

Subsequently, as illustrated in FIG.12A, the male housing 21 and the female housing 51 are faced to each other. The cam boss 35 of the lever 30 is inserted into the cam groove 65 of the frame 60 of the female connector 50 to be locked to the temporary locking protrusion 65a formed in the inlet of the cam groove 65. When the cam boss 35 of the lever 30 is locked to the temporary locking protrusion 65a of the cam groove 65, the male housing 21 of the male connector 20 and the female housing 51 of the female connector 50 come into a temporary set state. As illustrated in FIG. 12B, when the temporary set state is released, the male housing 21 is pulled out from the female housing 51 (pulled out in the temporary set releasing direction R illustrated in FIG. 4). The taper section 36a of the protrusion 36 provided on the outer side of the cam boss 35 slides on the temporary locking protrusion 65a of the cam groove 65. Consequently, the male connector 20 is smoothly separated from the female connector 50.

Subsequently, as illustrated in FIG. 13A, the lever 30 is rotated with the supporting shaft 24 of the male housing 21 as a rotation axis. The shaft section 35a of the cam boss 35 comes into contact with the drawing-in side sliding surface 65c of the cam groove 65 to draw in the female housing 51. When the female housing 51 is drawn in, the position restriction rib 35b of the cam boss 35 comes into contact with the drawing-in rib 65b of the cam groove 65 to keep the contact of the shaft section 35a of the cam boss 35 and the drawing-in side sliding surface 65c of the cam groove 65.

In that case, in a state in which the supporting shaft 24 of the male housing 21 is in slide-contact with the bearing hole 33 of the lever 30, the guide protrusion 25 of the male housing 21 moves along the arcuate guide groove 37 of the lever 30, whereby the lever 30 rotates.

Subsequently, as illustrated in FIG. 13A, when the rotation of the lever 30 is completed, the lever 30 is capable of sliding with respect to the male housing 21. In other words, when the rotation of the lever 30 ends, the guide protrusion 25 of the male housing 21 comes off the gathering taper 37a formed at an opening end of the arcuate guide groove 37 of the lever 30. Consequently, the lever 30 is capable of sliding with respect to the male housing 21.

As illustrated in FIG. 14, the operation section 31 of the lever 30 is pushed into slide the lever 30 along the guide protrusion 25 of the male housing 21 and locks the protrusion section 39a of the locking arm 39 of the lever 30 to the regular locking recess 27 of the male housing 21. In this case, the lever 30 comes into a regular locked state with respect to the male housing 21. When the lever 30 slides, the supporting shaft 24 of the male housing 21 comes into slide-contact with the shaft sliding groove 34 of the lever 30. The lever 30 is inserted into the frame 60 of the female housing 51 by the slide of the lever 30. Consequently, the fitting of the male housing 21 and the female housing 51 is completed.

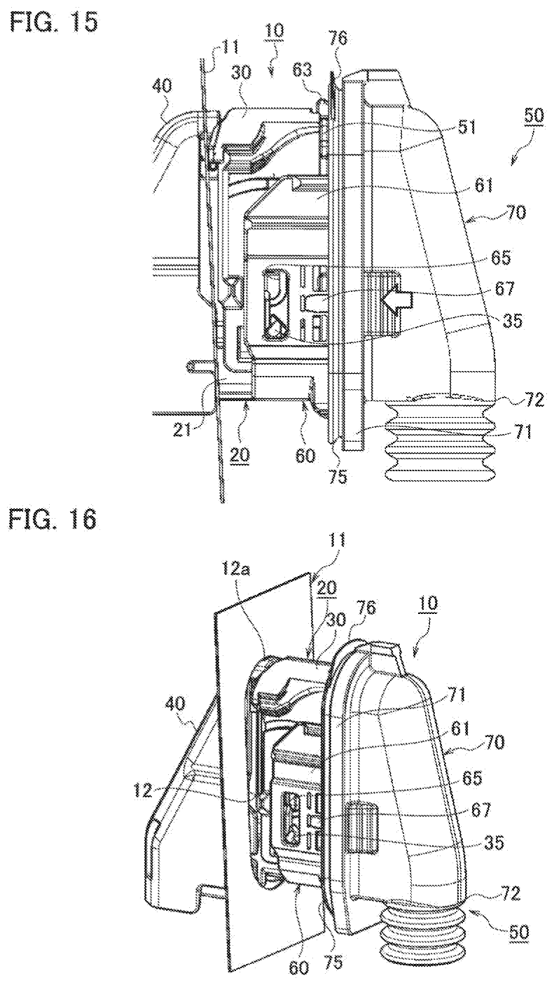

A procedure for assembling the lever-type connector 10, in which the male connector 20 and the female connector 50 are fit, to the attachment hole 12 of the vehicle body panel 11 will be described with reference to FIGS. 15 to 20.

As illustrated in FIGS. 15 and 16, the male connector 20 fit in the female connector 50 is pierced through the attachment hole 12 of the vehicle body panel 11 from the door panel side.

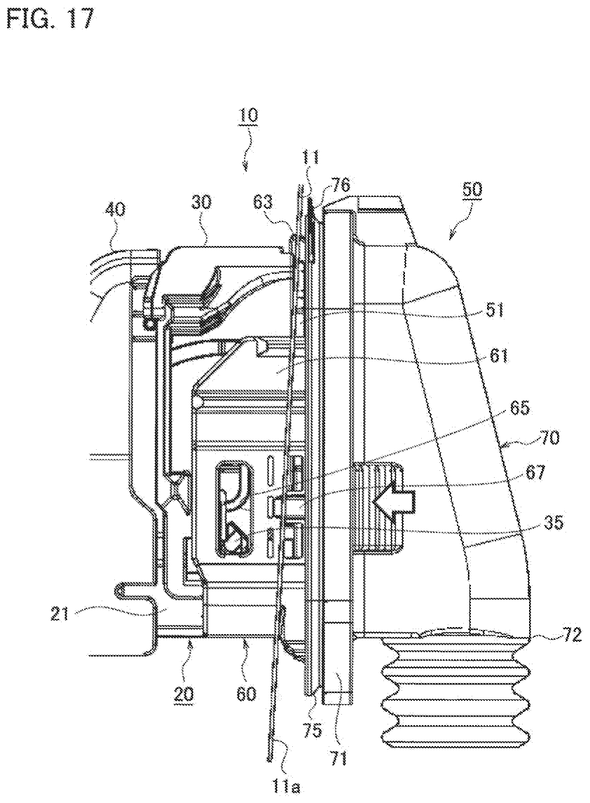

Subsequently, as illustrated in FIG. 17, the panel latching section 63 of the frame 60 of the female connector 50 is started to be inserted into the attachment hole 12 of the vehicle body panel 11.

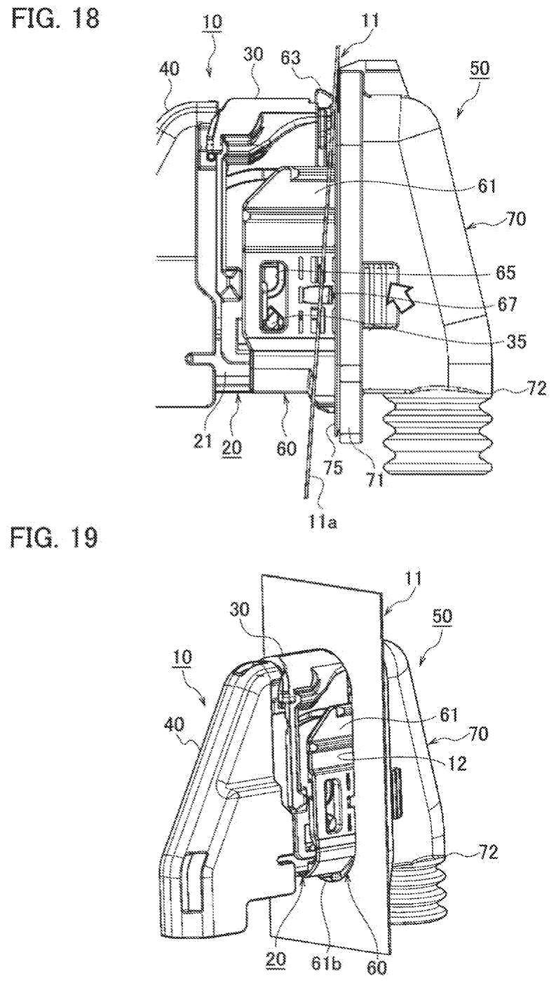

As illustrated in FIG. 18, the panel latching section 63 of the frame 60 is further inserted into the attachment hole 12 of the vehicle body panel 11. Consequently, the panel latching section 63 is latched to the edge portion 12a in a state in which the panel latching section 63 is hooked to the edge portion 12a of the attachment hole 12. As illustrated in FIG. 19, when the frame 60 is locked to the vehicle body panel 11 in a state in which the panel latching section 63 is not hooked to the edge portion 12a of the attachment hole 12 and is not latched to the edge portion 12a, the female connector 50 comes into contact with the abutting sections 61b, 61b of the frame 60 and the wall surface 11 a of the vehicle body panel 11. Therefore, the locking protrusion 67 of the frame 60 is not locked to the edge portion 12a of the attachment hole 12 of the vehicle body panel 11.

As illustrated in FIGS. 18 and 20, in a state in which the panel latching section 63 of the frame 60 is hooked to the edge portion 12a of the attachment hole 12 of the vehicle body panel 11, the female housing 51 is rotated with the panel latching section 63 as a fulcrum. Consequently, the inclined surface 67b of the locking protrusion 67 of the frame 60 comes into contact with the edge portion 12a of the attachment hole 12 and the flexible arm 66, in which the locking protrusion 67 is provided, bends. Therefore, the locking protrusion 67 of the frame 60 is locked to the attachment hole 12 of the vehicle body panel 11. In this case, as illustrated in FIG. 21, the locking protrusion 67 moves in a direction perpendicular to the vehicle body panel 11. Therefore, clearance h between the locking surface 67a of the locking protrusion 67 and the wall surface 11a of the vehicle body panel 11 is small. Consequently, the water-stop lip 75 of the grommet 70 is pressed against the wall surface 11 a of the vehicle body panel 11 without a gap. Therefore, it is possible to prevent intrusion of water from the attachment hole 12 of the vehicle body panel 11.

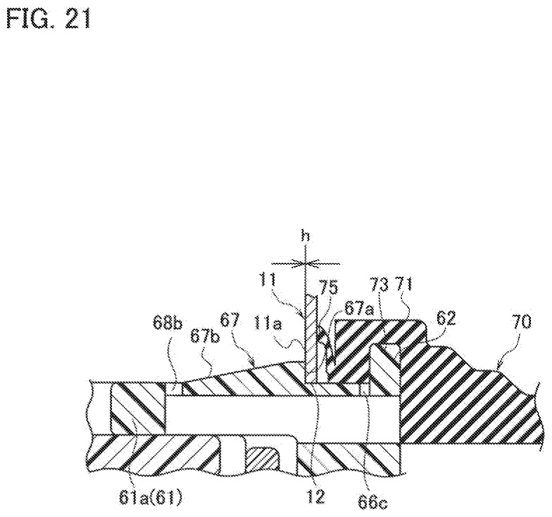

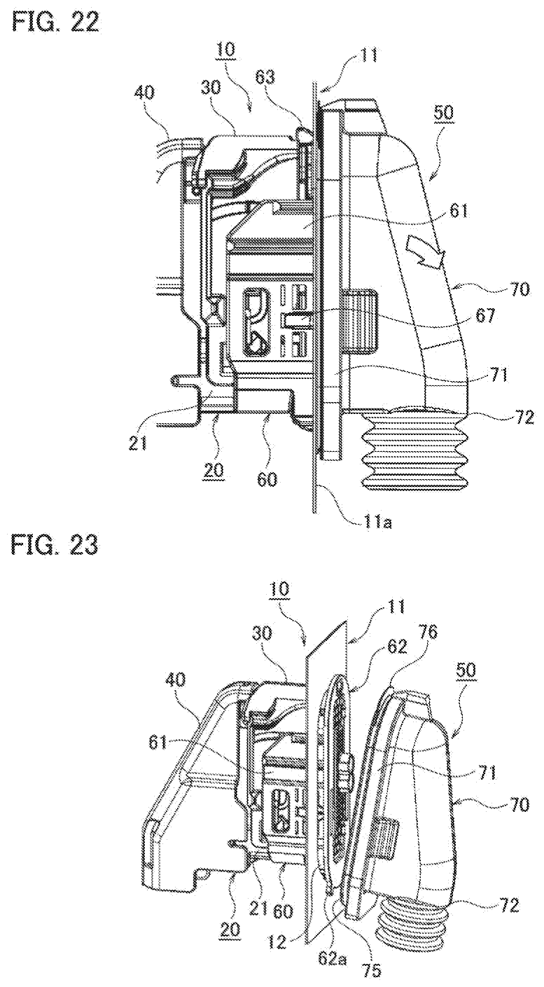

A procedure for removing the lever-type connector 10, in which the male connector 20 and the female connector 50 are fit, from the attachment hole 12 of the vehicle body panel 11 will be described with reference to FIGS. 22 to 30.

As illustrated in FIGS. 22 and 23, the grommet 70 is removed from the flange 62 of the female connector 50 assembled to the attachment hole 12 of the vehicle body panel 11.

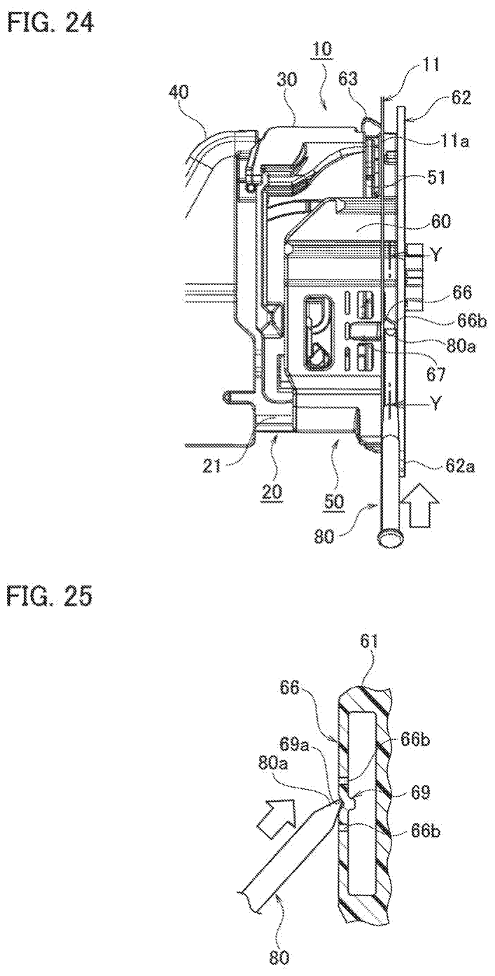

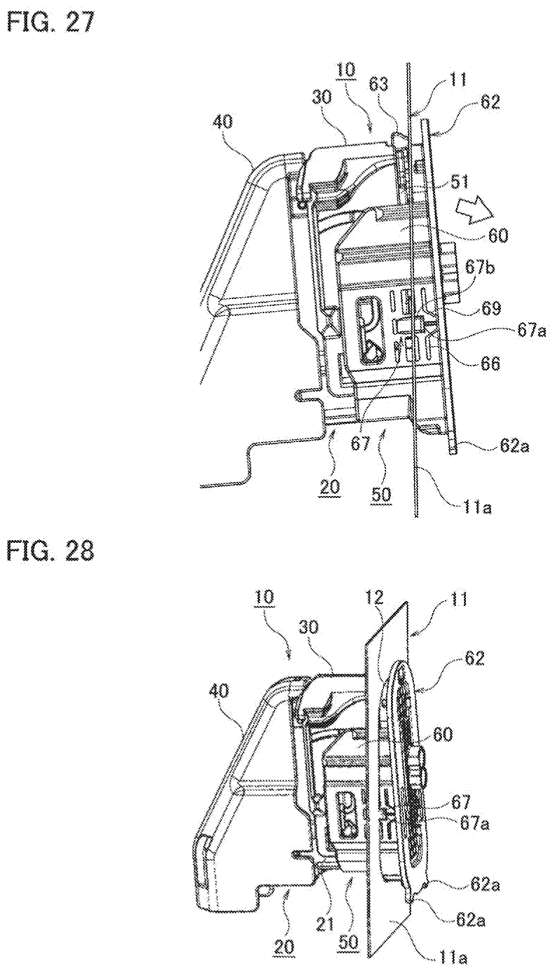

Subsequently, as illustrated in FIGS. 24 and 26A, the distal end 80a of the releasing jig 80 is inserted between the vehicle body panel 11 and the flange 62 of the female connector 50. The releasing jig 80 is moved to the releasing section 69 along the flange 62. In this case, as illustrated in FIGS. 9 and 26B, the insertion angle θ1 of the releasing jig 80 is set to an angle different from the inclination angle θ of the inclined slit 66b around the flexible arm 66. Therefore, the distal end 80a of the releasing jig 80 cannot enter the inclined slit 66b. With such a configuration, the flexible arm 66 is not damaged by the distal end 80a of the releasing jig 80. As illustrated in FIGS. 9 and 24, the insertion angle θ1 of the releasing jig 80 is set to the same angle as the angle θ2 of the recessed groove 69a of the releasing section 69. With such a configuration, the distal end 80a of the releasing jig 80 smoothly enters the recessed groove 69a of the releasing section 69. When the distal end 80a of the releasing jig 80 is pushed from a direction indicated by an arrow in FIG. 25 in this state, the flexible arm 66 bends to the inner side. As a result, as illustrated in FIGS. 27 and 28, the locking surface 67a of the locking protrusion 67 separates from the wall surface 11a of the vehicle body panel 11. The locked state is released. The locked state of the locking protrusion 67 present in the other sidewall section 61a in the frame 60 on the opposite side is released in the same manner.

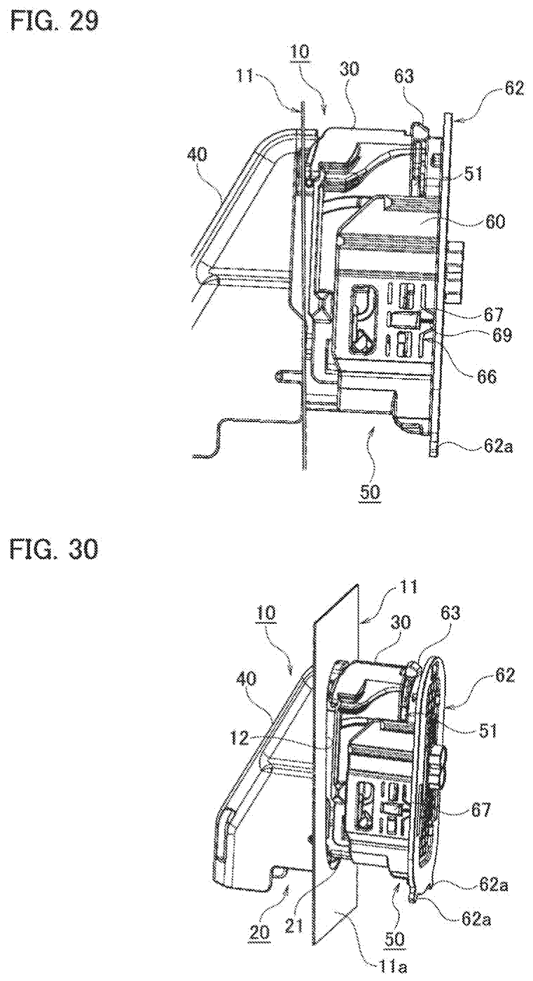

After the locking of the locking protrusions 67 on both the sides of the female connector 50 is released, the female connector 50 is pulled out from the attachment hole 12 of the vehicle body panel 11. The panel latching section 63 hooked to the attachment hole 12 of the vehicle body panel 11 is drawn out in a direction indicated by an arrow in FIG.27. As a result, as illustrated in FIGS. 29 and 30, the panel latching section 63 comes off the attachment hole 12. The lever-type connector 10 can be completely pulled out from the vehicle body panel 11.

In this embodiment, as illustrated in FIG. 21, the flexible arm 66 is elastically deformed when the lever-type connector 10 is assembled to the attachment hole 12 of the vehicle body panel 11. Therefore, the locking protrusion 67 moves in a direction perpendicular to the vehicle body panel 11. An urging force by elastic deformation of the auxiliary arm 68 provided around the flexible arm 66 is also applied to the locking protrusion 67. With such structure, it is possible to reduce the clearance h between the locking surface 67a of the locking protrusion 67 after the locking and the wall surface 11 a of the vehicle body panel 11. As a result, a backlash of the locking protrusion 67 with respect to the wall surface 11 a of the vehicle body panel 11 after being locked to the vehicle body panel 11 decreases. It is possible to stably maintain holding power of panel locking. Further, the water-stop lip 75 of the grommet 70 is pressed against the wall surface 11a of the vehicle body panel 11 without a gap. Therefore, it is possible to prevent intrusion of water from the attachment hole 12 of the vehicle body panel 11.

As illustrated in FIGS. 24 and 25, when the lever-type connector 10 is removed from the attachment hole 12 of the vehicle body panel 11, even in a situation in which the locking protrusion 67 of the female connector 50 is unseen, by moving the releasing jig 80 along the flange 62 of the female connector 50, it is possible to insert the distal end 80a of the releasing jig 80 into the recessed groove 69a of the releasing section 69. As a result, it is possible to perform releasing operation of the releasing section 69 without inserting the distal end 80a of the releasing jig 80 into the inclined slit 66b. Accordingly, it is possible to improve workability of removing the lever-type connector 10 from the attachment hole 12 of the vehicle body panel 11.

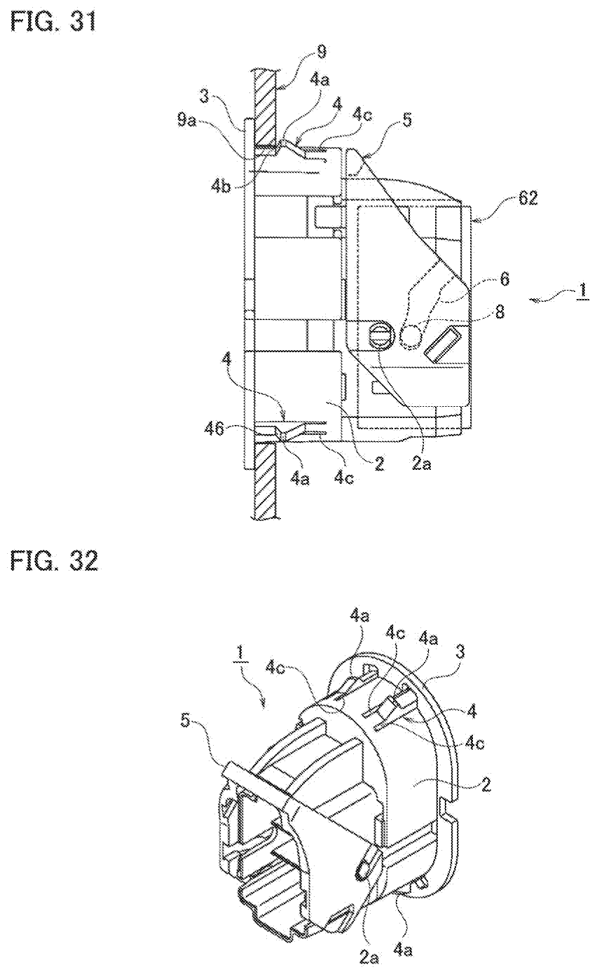

Next, a comparative example will be described. A lever-type connector 1 according to the comparative example includes, as illustrated in FIGS. 31 and 32, a first connector housing 2, a lever 5, and a second connector housing 7. The lever 5 turns with respect to the first connector housing 2 via a shaft section 2a. The second connector housing 7 includes a cam follower 8 that engages in a cam groove 6 of the lever 5. An elastic slip-off preventing piece 4 including a protrusion 4a is formed in a position slightly in front of a flange section 3 of the first connector housing 2. The elastic slip-off preventing piece 4 is locked to a hole edge of an attachment hole 9a of a panel 9 from the rear side.

The second connector housing 7 is fit in the first connector housing 2 by leverage generated by engagement of the cam groove 6 of the lever 5 and the cam follower 8 of the second connector housing 7. The lever-type connector 1 is attached by locking the protrusion 4a of the elastic slip-off preventing piece 4 of the first connector housing 2 to the attachment hole 9a of the panel 9 in this fitting state.

However, in the lever-type connector 1, a locking surface 4b of the protrusion 4a of the elastic slip-off preventing piece 4 of the first connector housing 2 is formed as a slope (a taper) in a coming-off direction. Therefore, clearance for the slope in the coming-off direction of the locking surface 4b causes a locking backlash. As a result, locking holding power of the protrusion 4a of the elastic slip-off preventing piece 4 decreases.

When the lever-type connector 1 is removed, a releasing jig is inserted between the panel 9 and the flange section 3 of the first connector housing 2. The elastic slip-off preventing piece 4 is displaced by the releasing jig to unlock the lever-type connector 1 from the panel 9. However, it is likely that the distal end of a releasing jig drops into a slit 4c beside the elastic slip-off preventing piece 4 to deteriorate removal workability and damage the elastic slip-off preventing piece 4.

According to this embodiment, the lever-type connector 10 is assembled to the vehicle body panel after the male connector is fit in the female connector. However, the present application is not limited to this. For example, the male connector may be fit in the female connector after the female connector is assembled to the vehicle body panel.

According to this embodiment, the female connector is configured by the female housing and the frame and the cam groove is provided in the frame. However, the present application is not limited to this. For example, the female connector may be configured by only the female housing and the cam groove may be provided in the female housing.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A connector comprising a housing, on an outer side of which a panel latching section hooked to an edge portion of an attachment hole of a panel and latched to the edge portion, an annular flange opposed to the edge portion, a flexible arm, and a locking protrusion holding the panel between the locking protrusion and the flange and locked to the panel are respectively formed, wherein
a slit is formed between the flange and the flexible arm,
the locking protrusion is formed in the flexible arm, and
in a state in which the panel latching section is hooked to the edge portion of the attachment hole, the housing is rotated with the panel latching section as a fulcrum to bring a locking surface of the locking protrusion into contact with a wall surface of the panel and lock the locking surface.

2. The connector according to claim 1, wherein a releasing section operated by collision of a distal end of a releasing jig inserted along the flange with the releasing section is formed between the locking protrusion of the flexible arm and the slit.

3. The connector according to claim 1, wherein an auxiliary arm is provided in a direction orthogonal to both sides of the locking protrusion of the flexible arm.

4. The connector according to claim 1, wherein
the slit is formed to incline, and
an inclination angle of the slit with respect to the flange is set to an angle different from an insertion angle of the releasing jig with respect to the flange at a time when the releasing jig is inserted along the flange.

5. The connector according to claim 2, wherein
a recessed groove is provided in the releasing section, and
an angle of the recessed groove with respect to the flange is set to a same angle as an insertion angle of a releasing jig with respect to the flange at a time when the releasing jig is inserted along the flange.

6. The connector according to claim 1, wherein
the housing includes a housing body and a tubular frame sheathed over the housing body,
the panel latching section is provided on an upper side of the frame, and
a pair of the locking protrusions is respectively provided in both sidewall sections of the frame.
